(19) United States
(12) Patent Application Publication
(10) Pub. No.: US 2009/0229432 A1
(43) Pub. Date: Sep. 17, 2009

(54) Punching method using punch and punch for punching

(75) Inventors: Shinichi Murata, Aichi (JP); Tetsufumi Yoshida, Kyoto (JP)

Correspondence Address: CARRIER BLACKMAN AND ASSOCIATES, 43440 WEST TEN MILE ROAD, EATON CENTER, NOVI, MI, 48375, US

(73) Assignees: Musashi Seimitsu Industry Co., Ltd., Toyohashi-shi (JP); Nichidai Corporation, Kyotanabe (JP)

(21) Appl. No.: 12/381,312

(22) Filed: Mar. 10, 2009

(30) Foreign Application Priority Data
Mar. 14, 2008 (JP) 2008-065891

(51) Int. Cl. B26F 1/14; B26F 1/02

(52) U.S. Cl. 83/13; 83/686

(57) ABSTRACT

An object of the present invention is to provide a punching method using a punch, which makes it possible to effectively improve the durability of a tooth portion of the punch. In a punching method using a punch for forming a through-hole in a workpiece by punching the workpiece using a punch, at least a tooth portion of the punch is made substantially solid when the workpiece is punched by the punch, and the tooth portion is made substantially hollow, thereby a diameter of the tooth portion is reduced by a reaction force received from the workpiece, when the workpiece is separated from the punch after the punching of the workpiece.

### BACKGROUND OF THE INVENTION

1. Field of the Invention

The present invention relates to a punching method using a punch for forming a through-hole in a workpiece by punching the workpiece using a punch and a punch for punching, which is employed for carrying out the method.

2. Description of the Related Art

Such a punching method using a punch and a punch for punching are known from the Japanese Patent Application Laid-open 2006-305599.

Conventionally, a punch used for punching a workpiece is entirely solid, and thus has a high rigidity. This makes it possible to enhance the precision in dimensions of the hole formed by the punching. In this case, in order to improve the durability of a tooth portion of the punch, attention has been directed to improvements in the material of the punch and the thermal processing performed thereon. However, even such approaches have certain limitations.

### SUMMARY OF THE INVENTION

The present invention has been made in view of the above-described circumstances, and an object of the present invention is to provide a punching method using a punch and a punch for punching, which make it possible to effectively improve the durability of a tooth portion of the punch.

In order to achieve the object, according to a first feature of the present invention, there is provided a punching method using a punch for forming a through-hole in a workpiece by punching the workpiece using a punch, the method comprising: making at least a tooth portion of the punch substantially solid when punching the workpiece by the punch; and when separating the workpiece from the punch after the punching of the workpiece, making the tooth portion substantially hollow, thereby to reduce a diameter of the tooth portion by a reaction force received from the workpiece.

With the first feature of the present invention, when the workpiece is punched using the punch, at least the tooth portion of the punch is made substantially solid. Accordingly, it is possible to secure the rigidity of the tooth portion, and thus to perform the punching with a high precision. On the other hand, when the punch is separated from the workpiece, the tooth portion is made substantially hollow, thereby a diameter of the tooth portion is reduced by the reaction force received from the workpiece. Accordingly, the friction force between the tooth portion and the workpiece can be reduced. As a result, it is possible not only to reduce the load required for separating the workpiece but also to effectively improve the durability of the tooth portion.

According to a second feature of the present invention, there is provided a punch for punching, which is employed for carrying out the punching method using a punch according to the first feature, comprising: a punch body including a tooth portion on an outer periphery of a tip end portion thereof, and a hollow portion in a center portion thereof; and a punch core slidably fitted into the hollow portion of the punch body, wherein the punch body and the punch core are configured so that, the punch core is tightly fitted to at least a part, corresponding to the tooth portion, of an inner peripheral surface of the hollow portion when a workpiece is punched by the tooth portion, and the punch core is separated from the inner peripheral surface when the workpiece is separated from the tooth portion after the punching.

With the second feature of the present invention, the punch has a simple structure including: a punch body including a tooth portion on an outer periphery of a tip end portion thereof, and a hollow portion in a center portion thereof; and a punch core slidably fitted into the hollow portion of the punch body. This simple structure also makes it possible to achieve the same effects as those of the first feature.

According to a third feature of the present invention, in addition to the second feature, the inner peripheral surface and an outer peripheral surface of the punch core which is capable of being tightly fitted to the inner peripheral surface are formed respectively into a female tapered surface and a male tapered surface each having a diameter decreasing in a direction in which the workpiece is separated from the tooth portion.

With the third feature of the present invention, in the punching of the workpiece by the tooth portion, the load applied from the workpiece to the tooth portion causes a wedging action between the female and male tapered surfaces tightly fitted to each other, and thus strengthens their tight fitting force. As a result, the solidity of the tooth portion, and further, the rigidity of the tooth portion can be effectively enhanced, so that the precision in the punching is further improved.

In addition, after the punching of the workpiece, when the punch body is moved with respect to the punch core, it is possible to also reduce the frictional resistance between the punch body and the punch core at an early stage, and also to separate the punch core from the inner peripheral surface of the tooth portion with a small amount of movement. Accordingly, this configuration contributes to an improvement in efficiency in the punching work.

An embodiment of the present invention is explained below by reference to a preferred embodiment of the present invention shown in the attached drawings.

### BRIEF DESCRIPTION OF THE DRAWINGS

FIGS. 1A and 1B are vertical sectional views illustrating an example of a workpiece to be punched using a punch.

FIG. 1A illustrates a state of the workpiece before the punching, and FIG. 1B illustrates a state of the workpiece after the punching.

FIG. 2 is a vertical sectional view illustrating a punching apparatus for carrying out the method of the present invention.

FIG. 3 is an enlarged view of a part indicated by the reference numeral 3 in FIG. 2.

FIG. 4 is an exploded view illustrating the punch in the punching apparatus.

FIG. 5 is a view corresponding to FIG. 2 and illustrating a state of the workpiece immediately after being punched using the punch.

FIG. 6 is a view corresponding to FIG. 5 and illustrating how the workpiece is extruded after the punching.

### DESCRIPTION OF THE PREFERRED EMBODIMENT

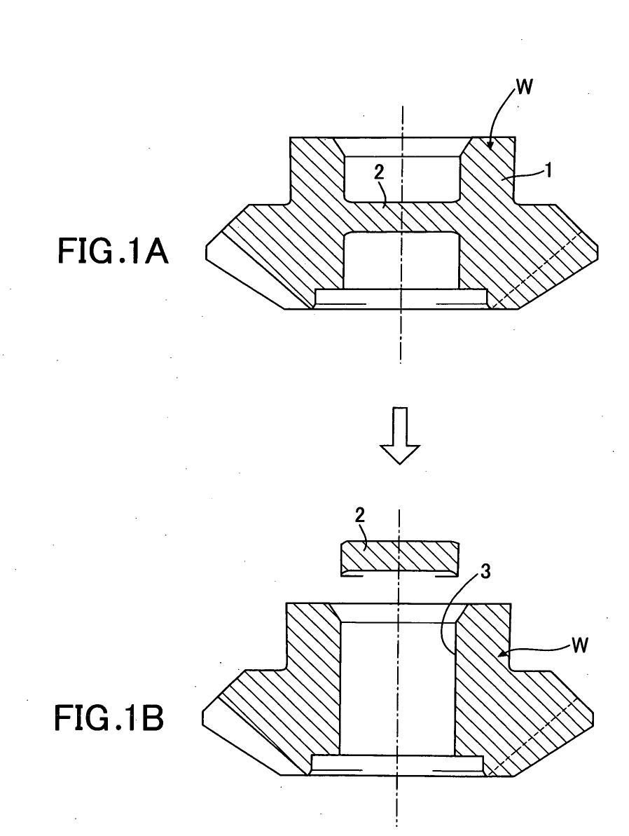

First, with reference to FIGS. 1A and 1B, an example of a workpiece to which the punching method of the present invention is employed will be described. A workpiece W illustrated in FIG. 1A is a semi-finished product of a bevel gear formed by a forging process, and a partition wall 2 remains in a middle of a hollow portion of a boss 1 of the workpiece W. As illustrated in FIG. 1B, the partition wall 2 is punched by the punching method of the present invention, so that a through-hole 3 is formed, thereby obtaining a finished product of the bevel gear.

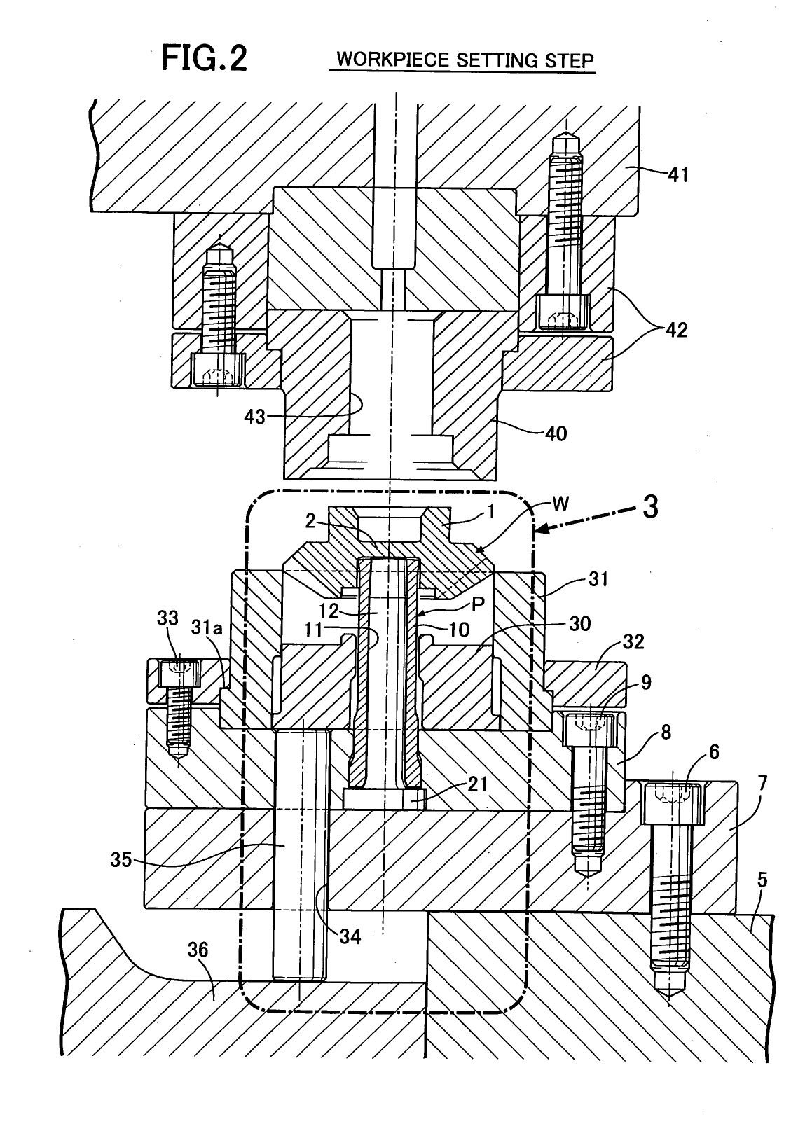

A punching apparatus for carrying out the punching method of the present invention will be described with reference to FIGS. 2 to 4.

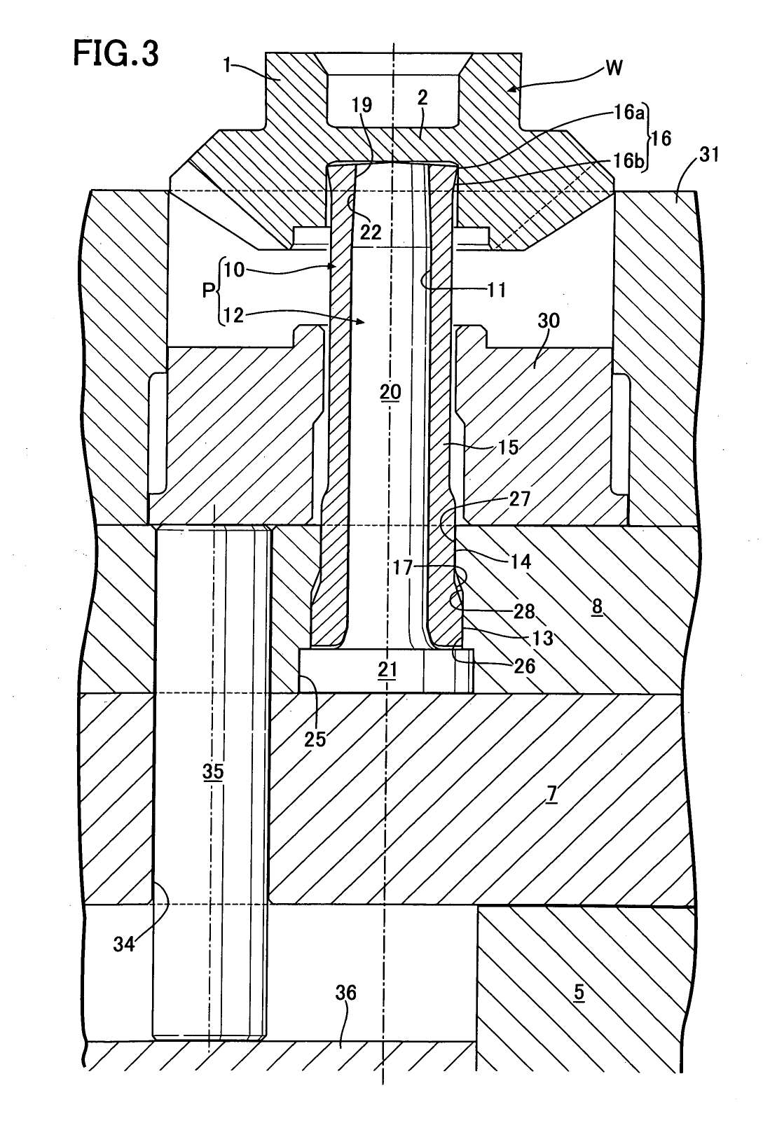

In FIGS. 2 and 3, a punch holder base 7 is fixed to a press stage 5 with a bolt 6, and a punch holder 8 for holding a punch P is fixed to the punch holder base 7 with a bolt 9.

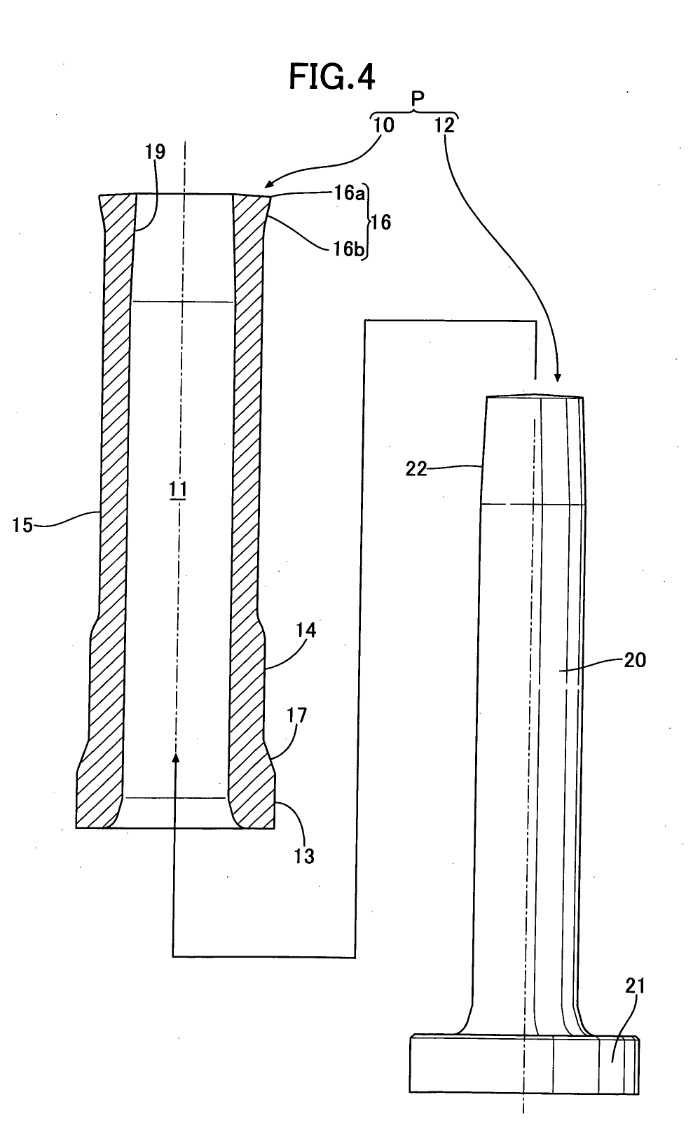

As illustrated in FIG. 4, the punch P includes a punch body 10 and a punch core 12 slidably fitted into a hollow portion 11 formed inside the punch body 10 over the entire length of the punch body 10 in an axial direction thereof. The punch body 10 basically has a cylindrical shape, and includes, from the lower end thereof: a first guide portion 13; a second guide portion 14 having a diameter smaller than that of the first guide portion 13; a shaft portion 15 having a diameter smaller than that of the second guide portion 14 and a length larger than the other portions; and a tooth portion 16 having an edge 16a which is formed on the outer periphery of the upper end thereof and which has a diameter larger than that of the shaft portion 15. A tapered first stopper surface 17 is formed between the first and second guide portions 13 and 14. A tapered undercut 16b having a diameter gradually decreasing from the edge 16a to the shaft portion 15 is formed on the outer periphery of the tooth portion 16. The tooth portion 16 can be fitted into the boss 1 so as to punch the partition wall 2 of the workpiece W.

A female tapered surface 19 is formed on the inner peripheral surface of the hollow portion 11 at least at a part corresponding to the tooth portion 16. The female tapered surface 19 has a diameter decreasing toward the upper end of the hollow portion 11.

On the other hand, the punch core 12 includes: a shaft portion 20 having an outer peripheral surface matching the inner peripheral surface of the hollow portion 11; and a flange 21 continuously provided at the lower end of the shaft portion 20. The flange 21 has a diameter larger than that of the first guide surface 13.

The outer peripheral surface of the upper end portion of the shaft portion 20 is formed into a male tapered surface 22 capable of tightly fitting into the female tapered surface 19 of the punch body 10. When the male tapered surface 22 is tightly fitted into the female tapered surface 19, the punch body 10 is located at its lowest position where the punch body 10 comes closest to the flange 21.

In FIGS. 2 and 3 again, the punch holder 8 has a holding hole 25 as well as first and second guide holes 26 and 27 formed therein. The holding hole 25 is fitted onto and thus holds the flange 21 of the punch core 12, while the first and second guide portions 13 and 14 of the punch body 10 are slidably fitted respectively into the first and second guide holes 26 and 27. Between the first and second guide holes 26 and 27, a tapered second stopper surface 28 is formed to prevent the punch body 10 from further moving up by coming into contact with the first stopper surface 17, when the punch body 10 is moved up by a predetermined distance from its lowest position relative to the punch core 12.

A workpiece receiving table 30 surrounding the punch P is disposed on the upper surface of the punch holder 8, and a workpiece receiving table guide 31 is fixed to the punch holder 8. The workpiece receiving table 30 is installed to be capable of moving up and down, and the workpiece receiving table guide 31 is slidably fitted onto the outer periphery of the workpiece receiving table 30 so as to guide the up and down movement of the workpiece receiving table 30. The workpiece receiving table guide 31 is fixed by using a hold down ring 32 engaged with an annular step portion 31a formed on the outer periphery of the workpiece receiving table guide 31, and a bolt 33 fixing the hold down ring 32 to the punch holder 8. The workpiece receiving table guide 31 is capable of receiving and accommodating the workpiece W moving down at the time of punching the partition wall 2 of the workpiece W

A plurality of guide holes 34 are formed in the punch holder 8 and the punch holder base 7. Each of the guide holes 34 vertically penetrates the punch holder 8 and the punch holder base 7 at a position immediately below the workpiece receiving table 30. A plurality of extruding pins 35 (only one of them is shown in FIG. 2), which are capable of coming into contact with the lower surface of the workpiece receiving table 30, are slidably inserted and fitted respectively into the guide holes 34. The extruding pins 35 are supported by an extruding block 36 which is driven to move up by a driving source such as a hydraulic cylinder.

A die 40 cooperating with the punch P is disposed coaxially above the workpiece receiving table 30. The die 40 is held by a die holder 42 fixed to a ram 41 which is driven to move up and down by a driving source such as a motor or a hydraulic cylinder. The die 40 is provided with a relief hole 43 which receives a scrap 2 generated by the punching using the punch P.

When the partition wall 2 of the workpiece W is punched, first as shown in FIG. 2, the boss 1 is fitted onto the outer periphery of the upper end portion of the punch P while the workpiece W is set to face in a predetermined direction, so that the partition wall 2 is supported on the end surface of the tooth portion 16. At this time, the extruding pins 35 are located at its down positions, so that the workpiece receiving table 30 is on the upper surface of the punch holder 8. The punch body 10 is located at its lowest position so as to come closest to the flange 21 of the punch core 12, so that the female tapered surface 19 of the punch body 10 is tightly fitted onto the male tapered surface 22 of the punch core 12. Accordingly, the punch P is substantially solid over its entire length in this state.

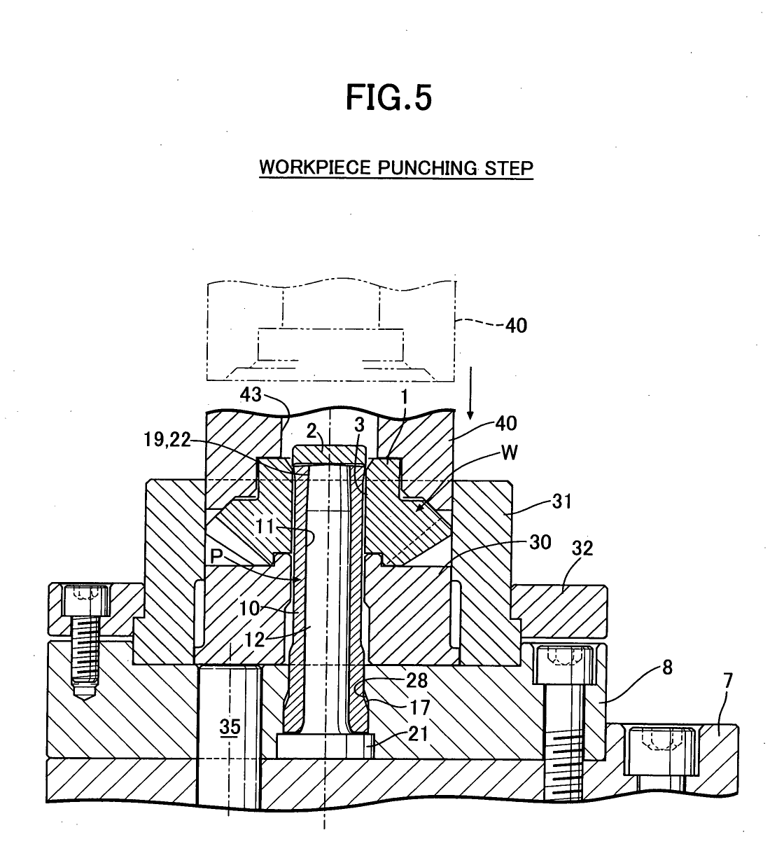

Subsequently, as shown in FIG. 5, the die 40 is moved down by the ram 41 so as to press the workpiece W until the workpiece W comes into contact with the workpiece receiving table 30. During this time, the partition wall 2 of the workpiece W is punched upward by the tooth portion 16 of the punch body 10, so that the through-hole 3 is formed in the boss 1. The partition wall 2 thus removed by the punching, i.e. the scrap 2 is pushed up to the relief hole 43 of the die 40 by the punch P.

In this punching, the tooth portion 16 receives the load from the workpiece W in a direction to reduce its diameter as a reaction force, and then, the load is tightly received by the punch core 12 from the tooth portion 16 through the female and male tapered surfaces 19 and 22 tightly fitted to each other. Accordingly, the rigidity of the tooth portion 16 is secured, so that the punching with a high precision can be performed.

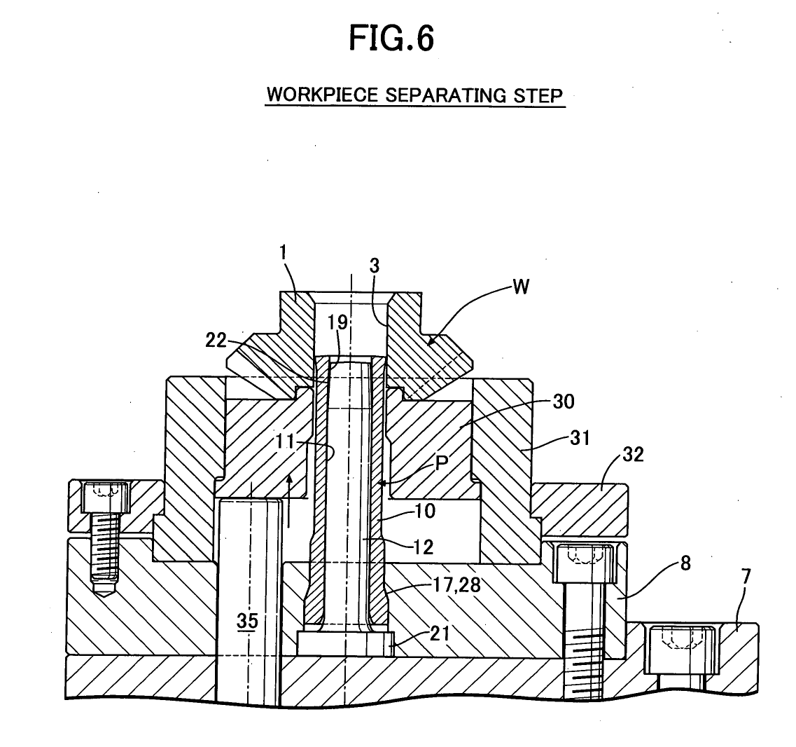

After the punching of the partition wall 2, the ram 41 is moved up, so that the die 40 is moved up and away from the workpiece W. Then, as shown in FIG. 6, the extruding block 36 is moved up to cause the extruding pins 35 to press up the workpiece receiving table 30 having the workpiece W placed thereon.

At this time, since a large friction force exists between the workpiece W and the tooth portion 16 of the punch body 10, the workpiece W thus moving up pulls up, with the friction force, the punch body 10 slidably fitted on the fixed punch core 12. As a result, the punch core 12 leaves from the inner peripheral surface of the tooth portion 16 of the punch body 10, so that the tooth portion 16 becomes substantially hollow. Accordingly, the tooth portion 16 unavoidably reduces its diameter by the reaction force received from the workpiece W. Consequently, the friction force between the tooth portion 16 and the workpiece W is decreased.

Once the punch body 10 is moved up with respect to the punch core 12 until the friction force between the tooth portion 16 and the workpiece W is decreased, the second stopper surface 28 of the punch body 10 comes into contact with the first stopper surface 17 of the punch core 12 so as to prevent the punch body 10 from further moving up. Accordingly, the moving up of the workpiece receiving table 30 by the extruding pins 35 thereafter pushes up only the workpiece W. At this stage, since the friction force between the tooth portion 16 and the workpiece W has already been decreased as described above, the workpiece W can be smoothly separated from the tooth portion 16. For this reason, it is possible not only to reduce the load required for separating the workpiece W but also to significantly improve the durability of the tooth portion 16.

Once the workpiece receiving table 30 reaches its upper end position, the workpiece W is pushed up to be located above the workpiece receiving table guide 31 so as to be removable therefrom.

Meanwhile, the female and male tapered surfaces 19 and 22, which are tightly fitted to each other on the inner peripheral side of the tooth portion 16, are formed respectively in the punch body 10 and the punch core 12. Accordingly, in the punching of the workpiece W by the tooth portion 16, the load applied from the workpiece W to the tooth portion 16 causes a wedging action between the female and male tapered surfaces 19 and 22 tightly fitted to each other, and thus strengthens their tight fitting force. As a result, the solidity on the inner peripheral side of the tooth portion 16, and further, the rigidity of the tooth portion 16 can be enhanced, so that the precision in the punching is further improved.

In addition, after the punching of the workpiece W, when the punch body 10 is moved up with respect to the punch core 12, it is possible to reduce the frictional resistance between the punch body 10 and the punch core 12 at an early stage, and also to separate the punch core 12 from the inner peripheral surface of the tooth portion 16 with a small amount of movement. Accordingly, this configuration contributes to an improvement in efficiency in the punching work.

The present invention is not limited to the above-described embodiment, and various modifications in design may be made thereon without departing from the scope of the present invention. For example, if the inner peripheral side of the tooth portion 16 is simply made hollow after the punching of the workpiece W, it is possible to replace each of the female and male tapered surfaces 19 and 22, which are tightly fitted to each other, with simple cylindrical surfaces. This case, however, does not entail the occurrence of the wedging action unlike the above-described embodiment, and also increases the amount of the upward movement of the punch body 10 for making the inner peripheral side of the tooth portion 16 hollow after the punching of the workpiece W.

What is claimed is:

1. A punching method using a punch for forming a through-hole in a workpiece by punching the workpiece using a punch, the method comprising:
making at least a tooth portion of the punch substantially solid when punching the workpiece by the punch; and
when separating the workpiece from the punch after the punching of the workpiece, making the tooth portion substantially hollow, thereby to reduce a diameter of the tooth portion by a reaction force received from the workpiece.

2. A punch for punching, which is employed for carrying out the punching method using a punch according to claim 1, comprising:
a punch body including a tooth portion on an outer periphery of a tip end portion thereof, and a hollow portion in a center portion thereof; and
a punch core slidably fitted into the hollow portion of the punch body, wherein
the punch body and the punch core are configured so that,
the punch core is tightly fitted to at least a part, corresponding to the tooth portion, of an inner peripheral surface of the hollow portion when a workpiece is punched by the tooth portion, and
the punch core is separated from the inner peripheral surface when the workpiece is separated from the tooth portion after the punching.

3. The punch for punching according to claim 2, wherein
the inner peripheral surface and an outer peripheral surface of the punch core which is capable of being tightly fitted to the inner peripheral surface are formed respectively into a female tapered surface and a male tapered surface each having a diameter decreasing in a direction in which the workpiece is separated from the tooth portion.
